(19) United States
(12) Patent Application Publication
(10) Pub. No.: US 2007/0296967 A1
(43) Pub. Date: Dec. 27, 2007

(54) Analysis of component for presence, composition and/or thickness of coating

(76) Inventors: Bhupendra Kumra Gupta, Cincinnati, OH (US); Nripendra Nath Das, West Chester, OH (US); Pamela King Benicewicz, Loudonville, NY (US)

Correspondence Address: GENERAL ELECTRIC COMPANY, GE AVIATION, ONE NEUMANN WAY MD H17, CINCINNATI, OH, 45215, US

(21) Appl. No.: 11/475,212

(22) Filed: Jun. 27, 2006

(51) Int. Cl. G01J 3/30; G01N 21/63

(52) U.S. Cl. 356/318

(57) ABSTRACT

A method comprising the following steps: (a) providing a turbine component comprising a metal substrate having an external surface; and (b) analyzing the external surface by laser plasma spectroscopy to determine whether a metallic coating is present on or absent from the external surface. If a metallic coating is determined to be present on the external surface, the elemental composition, elemental concentration and/or thickness of the metallic coating present on the external surface may be determined (qualitatively and/or quantitatively) by laser plasma spectroscopy. Another method comprises the following steps: (a) providing a turbine component comprising a metal substrate having an external surface which has been subjected to treatment to remove a metallic coating applied to the external surface; and (b) analyzing the treated external surface by laser plasma spectroscopy to determine the degree of removal of the metallic coating from the treated external surface.

### BACKGROUND OF THE INVENTION

This invention broadly relates to a method for determining whether or not a metallic coating is present on the external surface of a metal substrate of a turbine component. This invention also broadly relates to a method for determining the composition of any metallic coating detected on the external surface and/or the thickness of metallic coating present. This invention further broadly relates to a method for determining the degree of removal of a metallic coating from a treated external surface.

During operation of gas turbine engines, metal components of the engine, such as turbine blades and vanes used to direct the flow of the hot gases, as well as other components such as shrouds and combustors, may be in contact with hot, corrosive gases. These metal components may require protection from these hot, corrosive gases. In order to protect the metallic parts from the oxidative and corrosive effects of these gases, environmental coatings may be applied to the component.

These environmental coatings may be formed in an atmosphere rich in a certain element or elements, such as aluminum, nickel, platinum, etc., or combinations thereof. Using a process called chemical vapor deposition (CVD), these elements may be diffused into the surface of the component to form a diffusion coating, such as an aluminide diffusion coating, a diffusion nickel aluminide coating, or a platinum aluminide diffusion coating. Other methods used to form diffusion coatings may include “over the pack” aluminizing, pack aluminizing, flash electroplating of nickel and platinum onto a metal substrate followed by application of aluminum, etc. Diffusion coatings may also be used as bond coat layers for adhering other thermal barrier coatings to the metal substrate. Bond coat layers may also comprise overlay alloy bond coating materials such as MCrAlY alloys, wherein M is a metal such as iron, nickel, platinum, cobalt or alloys thereof.

Turbine blades used in compressors, turbines, vanes, blisks, etc., may comprise an airfoil having one or more internal cooling passages with openings or holes at the external surface(s) of the airfoil for the passage of cooling air out to remove heat from the interior of the airfoil and, in some cases, to provide a boundary layer of cooler air at the external surface of the airfoil. See, for example, commonly assigned U.S. Pat. No. 5,609,779 (Crow et al), issued Mar. 11, 1997; and U.S. Pat. No. 6,339,208 (Rockstroh et al.), issued Jan. 15, 2002. In addition to applying diffusion coatings to the external surface of the turbine airfoil, diffusion coatings such as aluminide diffusion coatings may also be applied to the surfaces of these internal cooling passages.

In some instances, the functional requirements of the protective coating for the external surface of the airfoil of a turbine blade or vane, and the surface of these internal cooling passages of the blade or vane may differ. As a result, the coating used to protect the external surface of the airfoil may differ compositionally from the coating used to protect the surface of the internal cooling passages. For example, the surface of the internal cooling passages may be protected with a simple aluminide coating, while the external surface of the airfoil may be protected with a nickel aluminide coating. Because of processing or other constraints it may become necessary to apply one of these diffusion coatings in a way that coats both the external surface of the airfoil as well as the surface of the internal cooling passages. For example, in forming a simple aluminide coating on the surfaces of the internal cooling passages, the aluminide coating may also be applied to the external surface of the airfoil. If another coating, such as a nickel aluminide diffusion coating, is already present on the external surface of the airfoil, this aluminide coating may form on top of this other existing coating.

The presence of a coating, such as a simple aluminide coating, intended to protect the surfaces of the internal cooling passages on either the external surface of the airfoil or over a previously applied external surface coating may be undesirable. As a result, it may become necessary to remove, for example, this simple aluminide coating before applying a different coating (e.g., nickel aluminide coating) intended to protect the external surface of the airfoil. After treating the applied aluminide coating to remove it from the external surface of the airfoil, it may also be necessary to analyze the external surface of the airfoil to determine the degree of removal of aluminide coating to ensure that this aluminide coating has been removed sufficiently before applying the external surface coating. Alternatively, it may be necessary to analyze the external surface of the airfoil to determine whether or not any coating already exists thereon, and if a coating does exist, what the composition of the coating is or might be.

One method that has previously been used to determine the presence or absence of coatings on the external surfaces of turbine components, such as blades and vanes, is commonly referred to as heat tinting. In heat tinting, the component to be analyzed is heated to a relatively high temperature of, for example, about 1100° F. (593.3° C.). As the component is heated, the color of the component is often visually observed to determine if a coating is or is not present. If the color changes during heating, this is often an indication that a coating is present on the external surface of the component. Often, this change in color is due to the formation of oxides of the metal(s) present in the coating.

Heat tinting as an analytical method for the presence or absence of coatings on the external surfaces of turbine components has a number of disadvantages. First, heat tinting is highly labor intensive. Heat tinting also requires a visual and subjective determination by the operator such that analyses may vary greatly depending on the operator's level of skill. Because of the high temperatures required, heat tinting may also alter the composition of any coating that is present, or may convert at least portions of the coating or the underlying metal substrate to various metal oxides that may require removal before the component may be used or processed further.

Accordingly, it would be beneficial to be able to analyze turbine components to: (1) determine the presence, composition and/or thickness of diffusion coatings or other metallic coatings; (2) in a manner that is more accurate than heat tinting, is minimally invasive and/or destructive of the component being analyzed, and (3) does not generate products that may require removal.

### BRIEF DESCRIPTION OF THE INVENTION

An embodiment of this invention is broadly directed at a method comprising the following steps:
(a) providing a turbine component comprising a metal substrate having an external surface; and
(b) analyzing the external surface by laser plasma spectroscopy to determine whether a metallic coating is present on or absent from the external surface.

Another embodiment of this invention is broadly directed at a method comprising the following steps:
(a) providing a turbine component having an external surface;
(b) analyzing the external surface by laser plasma spectroscopy to determine whether a metallic coating is present on or absent from the external surface; and
(c) if a metallic coating is determined to be present on the external surface, determining by laser plasma spectroscopy the elemental composition, elemental concentration and/or thickness of the metallic coating present on the external surface.

Another embodiment of this invention is broadly directed at a method comprising the following steps:
(a) providing a turbine component having an external surface which has been subjected to treatment to remove a metallic coating applied to the external surface; and
(b) analyzing the treated external surface by laser plasma spectroscopy to determine the degree of removal of the metallic coating from the treated external surface.

### BRIEF DESCRIPTION OF THE DRAWINGS

FIG. 1 is perspective view of a turbine blade with portions broken away to show the internal structure of the turbine blade having internal cooling passages.

FIG. 2 is an enlarged sectional view of the turbine blade of FIG. 1 taken along line 2-2.

FIG. 3 is a schematic diagram of an embodiment of an analytical system used in carrying out embodiments of the method of this invention.

FIG. 4 is schematic diagram of an alternative embodiment of an analytical system used in carrying out embodiments of the method of this invention.

FIG. 5 represents a spectrum taken of a representative platinum aluminide (PtAl) coating by laser plasma spectroscopy according to an embodiment of the method of this invention.

FIG. 6 represents a spectrum taken of a representative aluminide (Al) coating by laser plasma spectroscopy according to an embodiment of the method of this invention.

FIG. 7 represents a spectrum taken of a representative uncoated nickel (Ni)-cobalt (Co) N5 superalloy substrate by laser plasma spectroscopy according to an embodiment of the method of the this invention.

FIG. 8 represents a graphical display of an analysis of the aluminum (Al) to chromium (Cr) ratio of platinum aluminide coatings, aluminide coatings, and uncoated nickel-cobalt N5 superalloy substrates based on averaging peak Al and Cr emissions from many different spectra, such as those shown FIGS. 5-7.

FIG. 9 represents a graphical display illustrating a calibration of ablation depth versus ablation time for determining the thickness of a coating analyzed by laser plasma spectroscopy according to an embodiment of the method of the this invention.

### DETAILED DESCRIPTION OF THE INVENTION

As used herein, the term “turbine component” refers to any turbine component that comprises a metal substrate (i.e., the substrate is formed from metals or metal alloys), and includes turbine components comprising airfoils (e.g., blades, vanes, etc.), turbine disks (also referred to sometimes as “turbine rotors”), turbine shafts, turbine seal elements that are either rotating or static, including forward, interstage and aft turbine seals, turbine blade retainers, other static turbine components, etc. The metal substrate of the turbine component may comprise any of a variety of metals, or more typically metal alloys, including those based on nickel, cobalt and/or iron alloys. The metal substrate typically comprises a superalloy based on nickel, cobalt and/or iron. Such superalloys are disclosed in various references, such as, for example, U.S. Pat. No. 4,116,723 (Gell et al.), issued Sep. 26, 1978; and commonly assigned U.S. Pat. No. 4,957,567 (Krueger et al.), issued Sep. 18, 1990; U.S. Pat. No. 5,399,313 (Ross et al.), issued Mar. 21, 1995; and U.S. Pat. No. 6,521,175 (Mourer et al.), issued Feb. 18, 2003, the relevant portions of which are incorporated by reference. Superalloys are also generally described in Kirk-Othmer's Encyclopedia of Chemical Technology, 3rd Ed., Vol. 12, pp. 417-479 (1980), and Vol. 15, pp. 787-800 (1981). Illustrative nickel-based superalloys are designated by the trade names Inconel®, Nimonic®, René® (e.g., René® 80, René® 88, René® 104, and René® N5 alloys), and Udimet®.

As used herein, the term “metallic coating” refers to a coating that consists essentially of metal or metal alloys (i.e., is a not a ceramic coating, such as a metal oxide). The metallic coating may be a protective coating for the metal substrate of the turbine component, a bond coat layer for adhering a thermal barrier coating comprising a ceramic (e.g., yttria-stabilized zirconia) to the metal substrate, etc. These metallic coatings may comprise diffusion coatings, overlay metal alloy coatings, etc.

As used herein, the term “diffusion coating” refers to coatings comprising various noble metal aluminides such as nickel aluminide, platinum aluminide, etc., as well as simple aluminides (i.e., those formed without noble metals), and may be formed on metal substrates by chemical vapor phase deposition (CVD), pack cementation, vapor phase aluminiding, “over the pack” aluminizing, pack aluminizing, flash electroplating of nickel and platinum onto a metal substrate followed by application of aluminum, etc. Diffusion coatings normally comprise two distinct zones or layers, the outermost of which is an additive layer containing an environmentally-resistant intermetallic; beneath this additive layer is a diffusion zone or layer comprising various intermetallic phases that form during the coating process as a result of diffusional gradients and changes in elemental solubility in the local region of the adjacent metal substrate.

As used herein, the term “overlay metal alloy” refers to metal alloys having the formula MCr, MAl, MCrAl, MCrAlX, or MAlX, wherein M is nickel, cobalt, iron, etc., or an alloy thereof, and wherein X is hafnium, zirconium, yttrium, tantalum, platinum, palladium, rhenium, silicon, lanthanum, etc., or a combination thereof. Typically, the overlay metal alloys used herein are MCrAlY alloys, and more typically wherein M is nickel, cobalt, or a nickel-cobalt alloy and wherein X is yttrium (i.e., Y).

As used herein, the terms “Laser Plasma Spectroscopy (LPS)”, “Laser-Induced Breakdown Spectroscopy (LIBS)” and/or Laser-Induced Plasma Spectroscopy (LIPS) (collectively referred to herein as “LPS”) refer to a type of atomic emission spectroscopy which utilizes a highly energetic laser pulse as the excitation source. LPS analyzes matter regardless of its physical state, be it solid, liquid or gas. Because all elements emit light when excited to sufficiently high temperatures, LPS may detect all elements, limited only by the power of the laser as well as the sensitivity and wavelength range of the spectrometer and detector. The elemental composition of the material irradiated during LPS may then be accurately determined through spectral analysis of light radiation emitted from the plasma generated. LPS may also have certain advantages over other types of elemental analytical techniques, for example, in not requiring extensive preparation of a sample to be analyzed, vaporizing only a small quantity of the sample (e.g., on the order of nanograms) during analysis, performing the analysis of the sample fairly rapidly, identifying multiple constituent elements at the same time, etc. In accordance with an embodiment of an LPS analytical technique, light output from a pulsed laser may be focused onto the surface of the sample to be analyzed. Assuming the focused laser pulse has sufficient intensity, a small amount of material at the surface of the sample is vaporized, thus forming a high-temperature plasma which corresponds to the elemental constituents of the vaporized material and which comprises ions and excited atoms that emit light radiation as the ions and excited atoms de-excite. The elemental composition of the irradiated material may then be accurately determined through temporally resolved spectral analysis of the light radiation emitted from the plasma. Multiple plasma generating laser pulses may be used in succession to obtain additional spectral data to improve the accuracy of the analysis.

As used herein, the terms “spectrophotometer” and “spectrometer” (hereafter collectively referred to as “spectrometer”) refer to an analytical device used to separate the optical emissions from the plasma by their wavelength. In combination with an appropriate detector (e.g., an ICCD camera), the spectrometer enables a determination of the intensity of the plasma emissions as a function of wavelength. The ionic and atomic emissions from each element are unique, and may thus be used to identify the presence, absence and/or concentration of an element in the vaporized portion of the sample.

As used herein, the term “qualitative analysis” refers to an analysis that yields an identification of the elements present in the plasma generated by LPS. Qualitative analysis may be used, for example, to determine the presence or absence of a metallic coating in an analyzed sample, the elemental composition of any metallic coating present in an analyzed sample, the identification of a particular coating type as opposed to another coating type in an analyzed sample, etc.

As used herein, the term “quantitative analysis” refers to an analysis that determines the particular concentration or concentrations of the elements by evaluation of the plasma plume generated by LPS. Quantitative analysis may be used to determine elemental concentrations in the metallic coating present in an analyzed sample, elemental concentration as a function of depth into the coating in an analyzed sample, etc. The thickness of the metallic coating present on an analyzed sample may also be determined by monitoring one or more spectral emissions from a laser-generated plasma using LPS as a function of depth, together with a known calibration (e.g., ablation rate calibration curve) which has been performed to associate depth penetration with a number of successive laser shots or pulses (or time associated with such shots or pulses) applied to or striking the sample surface.

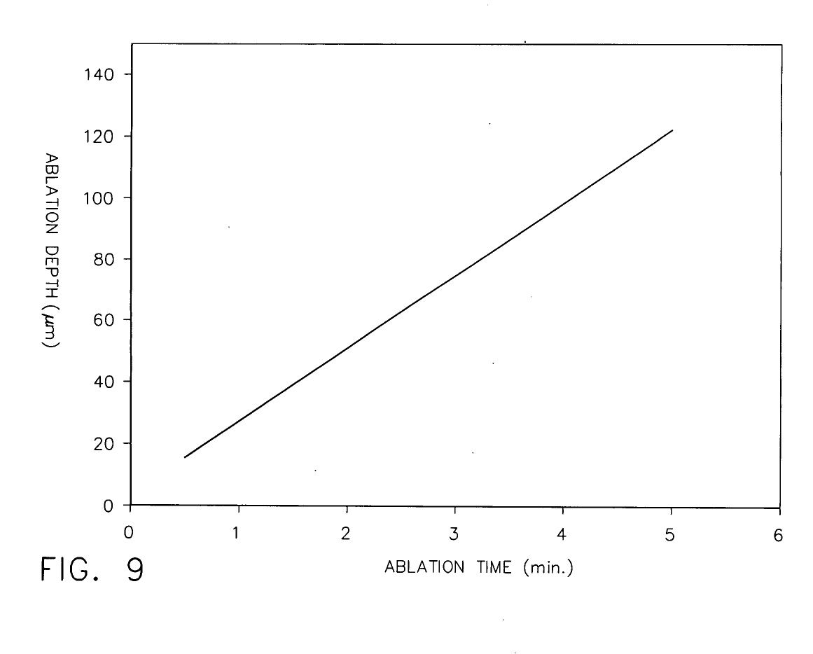

As used herein, the term “ablation rate calibration curve” refers to a curve such at that shown in FIG. 9 wherein the ablation depth is plotted versus the ablation time and which may be used to determine the thickness of a metallic coating subjected to LPS.

As used herein, the term “ablation depth” refers to the depth that a laser pulse or pulses penetrates into a coating, substrate or both during LPS.

As used herein, the term “ablation time” refers to amount of time that a laser pulse or pulses strike a sample during LPS.

As used herein, the term “marker element” refers to an element measured by LPS which may be used to differentiate alone, or in combination with one or more other marker elements, the elemental composition, elemental concentration and/or thickness of the metallic coating, metal substrate, or both.

As used herein, the term “resolved spectra” refers to a signal or signals generated by LPS which have been spectrally and temporally resolved such that the signal or signals have been identified and correlated to differentiate one or more metallic coatings and/or metal substrates.

Embodiments of the method of this invention are based on the discovery that analysis of the surface of turbine components, such as turbine blades and vanes, may be carried out by using laser plasma spectroscopy (LPS) to determine: (1) the presence or absence of a metallic coating on the external surface of the metal substrate of a turbine component; (2) if a metallic coating is present, the type and composition of the metallic coating, the thickness, etc., of the metallic coating, etc.; (3) if the external surface has been subjected to treatment to remove the metallic coating, the degree of removal of the metallic coating from the treated surface. Because LPS may be carried out selectively on a very small portion or section of the turbine component, it is less invasive and destructive compared to heat tinting in analyzing for metallic coatings on the external surface of metal substrates of turbine components. This includes avoiding the need to subject the turbine component to treatments (e.g., grit blasting) to remove reaction products (e.g., metal oxides) that may be created on the external surface of the metal substrate by the analytical method. LPS may also be more accurate compared to heat tinting in determining the presence, composition, concentration, and thickness of the metallic coating present on the external surface of the metal substrate of the turbine component. In other words, LPS may provide a qualitative analysis, quantitative analysis, or both a qualitative and quantitative analysis of any metallic coating that may or may not be present on the surface of the turbine component.

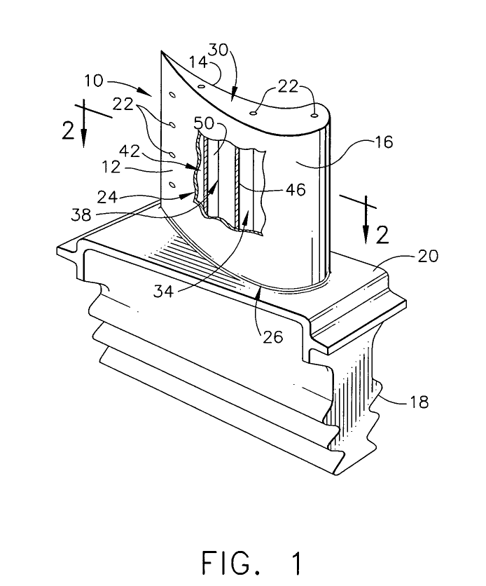

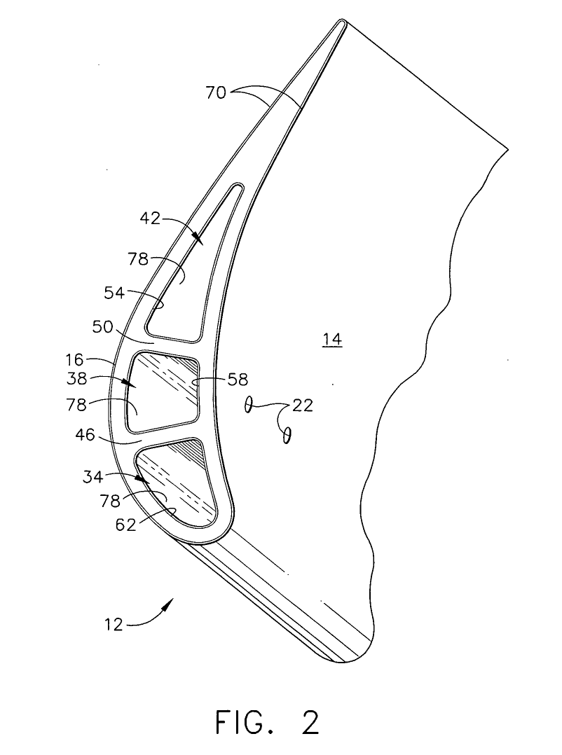

An illustration of a turbine component for which embodiments of the LPS analytical method of this invention may be useful is illustrated in FIGS. 1 and 2. Referring to the drawings, FIG. 1 shows a gas turbine engine component comprising an airfoil in the form of a turbine blade identified generally as 10. (Turbine vanes have a similar appearance to turbine blades 10 with respect to the pertinent portions.) Blade 10 comprises an airfoil 12 against which hot combustion gases are directed during operation of the gas turbine engine, and whose surfaces may therefore be subjected to high temperature environments. Airfoil 12 has a “high-pressure side” indicated as 14 that is concavely shaped; and a suction side indicated as 16 that is convexly shaped and may sometimes be known as the “low-pressure side” or “back side.” In the operation of a gas turbine engine, the hot combustion gas is directed against the high-pressure side 14. Blade 10 may be anchored to a turbine disk (not shown) with a dovetail 18 that extends from platform 20 of blade 10 and may be received by slots along the periphery of the disk.

As shown in FIG. 1, there are a plurality of openings or holes indicated as 22 that are formed in convexly shaped low-pressure suction-side 16; a similar plurality of openings or holes 22 may also be formed in concavely-shaped high-pressure side 14. These openings or holes 22 may be formed in sides 16 and 14 to connect with one or more internal cooling passages extending through the interior indicated generally as 24 of the airfoil 12, from the root end indicated as 26 adjacent to dovetail 18, to the opposite distal tip end indicated as 30 remote from dovetail 18 that may also have openings or holes 22 that connect to the interior 24 of airfoil 12. While interior 24 of airfoil 12 may be provided with one such internal cooling passage (i.e., interior 24 of airfoil 12 is essentially hollow), FIG. 1 and especially FIG. 2 show interior 24 of airfoil 12 as having a plurality of such passages indicated as leading edge passage 34, central passage 38 and trailing edge passage 42 that are separated, respectively, by forward internal wall 46 and rearward internal wall 50, and that have internal surfaces indicated, respectively, as 54, 58 and 62.

Airfoil 12 may also be provided with a metallic coating that may be applied to the external surfaces of sides 14 and 16, to internal surfaces 54, 58 and 62, or both external surfaces of sides 14 and 16 and internal surfaces 54, 58 and 62. For example, an external metallic coating (e.g., diffusion coating) represented by an external coating layer, indicated generally as 70, may be present on the external surfaces of sides 14 and 16,. For the internal surfaces 54, 58 and 62, an internal metallic coating (e.g., diffusion coating) represented by an internal coating layer, indicated generally as 78, may be present on these internal surfaces 54, 58 and 62. In some embodiments of blade 10, external layer 70 may differ in composition from internal layer 78. For example, external layer 70 may comprise a nickel aluminide diffusion coating, while internal layer 78 may comprise a simple aluminide diffusion coating. Because of the manner in which the internal layer 78 is applied to internal surfaces 54, 58 and 62, the diffusion coating comprising internal layer 78 may also be present on the external surfaces of sides 14 and 16, or if external layer 70 has already been applied to these external surfaces of side 14 and 16, on top of external layer 70.

One embodiment of the method of this invention broadly comprises analyzing the external surface of a metal substrate of a turbine component, such as blade 10, by LPS to determine whether a metallic coating is present on or absent from the external surface. For example, the external surface of sides 14 and 16 may be analyzed to determine whether a simple aluminide diffusion coating is or is not present on these external surfaces. An LPS system that may be used to analyze these external surfaces of sides 14 and 16 of blade 10 may comprise a pulsed laser (e.g., a neodymium doped yttrium aluminum garnet (Nd:YAG) solid state laser), a spectrometer with a wide spectral range and a high sensitivity, fast response rate, a time gated detector, as well as other components such as optical fibers, lenses, beam splitters, controllers, etc. This system may include or be coupled to a computing device which may rapidly process, interpret, display, etc., the acquired or collected data. Suitable LPS analytical systems for use herein may include those disclosed in commonly assigned U.S. Pat. No. 6,762,836 (Benicewicz et al.), issued Jul. 13, 2004; and commonly assigned published U.S. Patent Application No. 2005/0068524 (Wu et al.), published Mar. 31, 2005, the relevant disclosures of which are incorporated by reference.

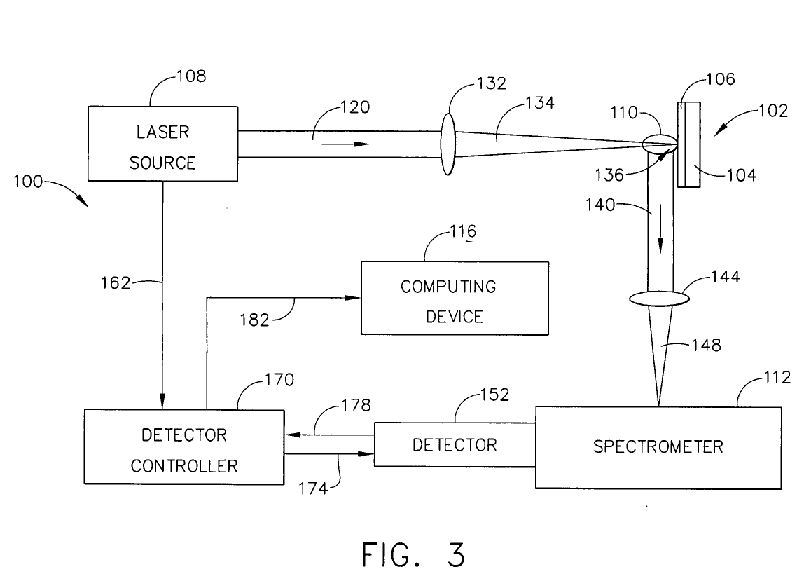

An embodiment of an LPS system, indicated generally as 100, which may be used to analyze external surfaces of sides 14 and 16 of blade 10 is illustrated in FIG. 3. FIG. 3 shows a block diagram of system 100 that may be portable or stationary for performing LPS analysis on a turbine component sample (for example, blade 10), indicated generally as 102, which comprises a metal substrate, indicated as 104, and a metallic coating, indicated as 106, overlaying substrate 104. System 100 includes a laser source, indicated generally as 108, which may comprise a laser and associated power supply. The laser from source 108 may be used to vaporize a portion of the material comprising coating 106 from sample 102 to generate a luminous plasma plume, indicated as 110, for spectral analysis by a spectrometer, indicated generally as 112. The spectral analysis by spectrometer 112 may then be represented, for example, on a display screen of a computing device, indicated generally as 116, may be provided as a graphical representation, may be reported as digital data, etc.

As shown in FIG. 3, the laser of source 108 generates a laser pulsed output beam 120. In carrying out LPS, the amount of energy which may be supplied in output beam 120 from the laser of source 108 (e.g., a nanosecond pulsed laser) may be in the range of from about 1 to about 50 mJ, or greater with focused output power densities of about 1 GW/cm² or greater. Output beam 120 may be focused by lens 132 to provide focused beam 134 which strikes a small portion, section or area, indicated as 136, of the surface of coating 106 of sample 102. As a result, a small quantity of surface material from coating 106 in area 136 is vaporized, forming a high-temperature luminous plasma plume 110. Light radiation emissions emanating from plasma plume 110 may be collected, as indicated by 140, and then focused or imaged by lens 144 as a focused or imaged beam 148 onto a front entrance slit (not shown) of spectrometer 112 to perform a spectral analysis. Upon passing through spectrometer 112, the light from beam 148 is spectrally dispersed and focused onto the front face of detector 152, which may comprise, for example, a conventional photo-diode array (PDA), an intensified charge-coupled device (ICCD), etc.

As further shown in FIG. 3, the power supply from laser source 108 may generate an electronic trigger-to-logic (TTL) output pulse, indicated by arrow 162, which may be synchronized to the emission of the laser pulse, and which may be used to send a triggering signal to detector controller 170. Detector controller 170 may, via computer resident software, generate a gate pulse, indicated by arrow 174, of a chosen width and delay with respect to the generation of the laser pulse to activate detector 152 at a desired time and for a desired duration. Detector controller 170 may activate detector 152 for a predetermined duration at a predetermined time after the laser pulse (i.e., beam 134) strikes sample 102 to form plasma plume 110. A signal, indicated by arrow 178, transmits data collected by detector 152 to detector controller 170. Detector controller 170 then transmits the collected data as a signal, indicated by arrow 182, to computing device 116.

In an embodiment of system 100 shown in FIG. 3, computing device 116 may comprise a laptop/portable computer. Computing device 116 may be electronically coupled to the output of detector controller 170 by any conventional means, such as a conventional IEEE-232 serial interface, PCI bus, etc. The emission spectra from one or more plasma events from spectrometer 112/detector 152 pair may be analyzed in real-time and displayed or saved by computing device 116 for future evaluation. Various commercial software packages for performing such analyses are available and may be used for programming computer device 116 for collecting, resolving, displaying, archiving, etc., emission spectra data obtained from spectrometer detector 152. For example, a Microsoft Windows™ based software package such as Princeton Instruments' Winspec or Acton Research's SpectraSense™, available from Roper Scientific, Inc., may be used. Sophisticated data processing may also be performed via LabView.

Once an emission spectral profile of plasma plume 110 is created, a comparison and matching of the spectral profile may be performed in situ either manually or automatically against a reference source of known emission spectra to determine the elemental composition (i.e., elemental constituents) of the vaporized portion of sample 102. A database containing reference spectral profiles of selected elements and/or compounds may be created and stored, for example, within computing device 116 for in situ access and display. Alternatively, computing device 116 may be provided with conventional means to access a remotely located database containing emission spectra information through a conventional wired or wireless communications link, a telephone line, the Internet, etc.

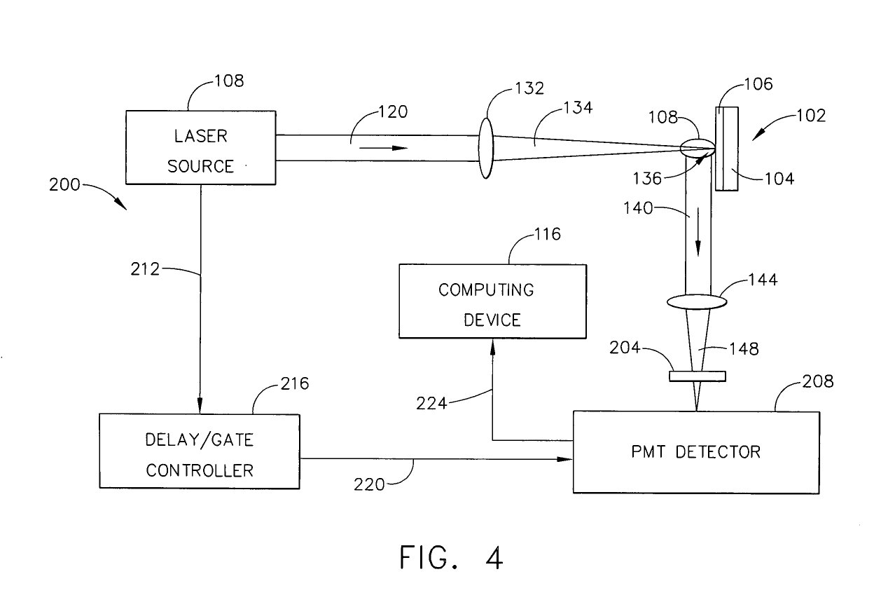

Once a spectrally and temporally resolved signal or signals have been identified and correlated (i.e., “resolved spectra” have been obtained) to differentiate the various coatings 106 and substrates 104, the spectrometer 112/detector 152 pair of system 100 may be replaced with a detector/filter pair to acquire or collect only selected emissions of interest from sample 102, as is illustrated by the schematic diagram of an alternative analytical system, indicated generally 200, and shown in FIG. 4. By substituting a smaller detector/filter pair for the larger spectrometer 112/detector 152 pair, system 200 may provide greater portability for use in making spectra analyses of samples 102 in the field.

As shown in FIG. 4, system 200 also comprises a laser from source 108 which again generates a laser pulsed output beam 120 which is then focused by lens 132 to provide focused beam 134 which strikes area 136 of the surface of coating 106 of sample 102. Again, a small quantity of surface material from coating 106 in area 136 is vaporized to form plasma plume 110. Light radiation emissions 140 emanating from plasma plume 110 are again collected, but focused beam 148 from lens 144 is instead imaged through narrow bandpass filter 204 and onto the front face of photo-multiplier tube (PMT) detector 208. The predetermined narrow bandpass of filter 204 may be selected so as to transmit only a narrow range of selected wavelengths that encompasses ionic or atomic emissions of interest coming from the surface of coating 106 of sample 102. Bandpass filter 204 may comprise, for example, a conventional Fabry-Perot interference filter having a very narrow transmission bandwidth (e.g., from about 1 to 10 nm). Alternatively, filter 204 may comprise a tunable acousto-optic filter to transmit wavelengths within a narrow band (4 nm), wherein the central wavelength of such narrow band may be varied depending on the particular atomic emission that is to be transmitted. The laser of source 108 may generate a TTL output pulse, indicated by arrow 212, which may be synchronized to the emission of the laser pulse, and which may be used to send a triggering signal to delay/gate controller 216. Delay/gate controller 216 provides a gate pulse (on-off activation) at a predetermined delay, which is transmitted as a signal, indicated by arrow 220, to PMT detector 208. A signal indicative of an amount of light of a particular wavelength received by PMT detector 208 may be transmitted as signal, indicated by arrow 224, to computing device 116 which may be provided with a display screen or monitor to display the transmitted signal 224. When monitoring, for example, two emissions simultaneously, a beam splitter (not shown) may be placed after lens 144 to divide the focused beam 148 into two portions, with one portion then being transmitted through a first narrow bandpass filter 204 and onto a first PMT detector 208, with the other portion being transmitted through second narrow bandpass filter 204 and onto second PMT detector 208.

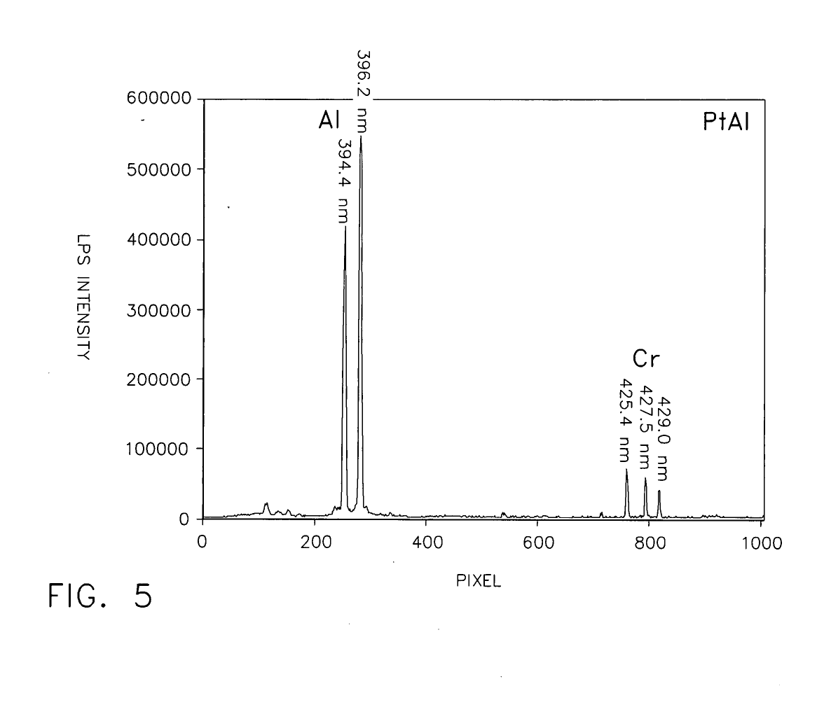

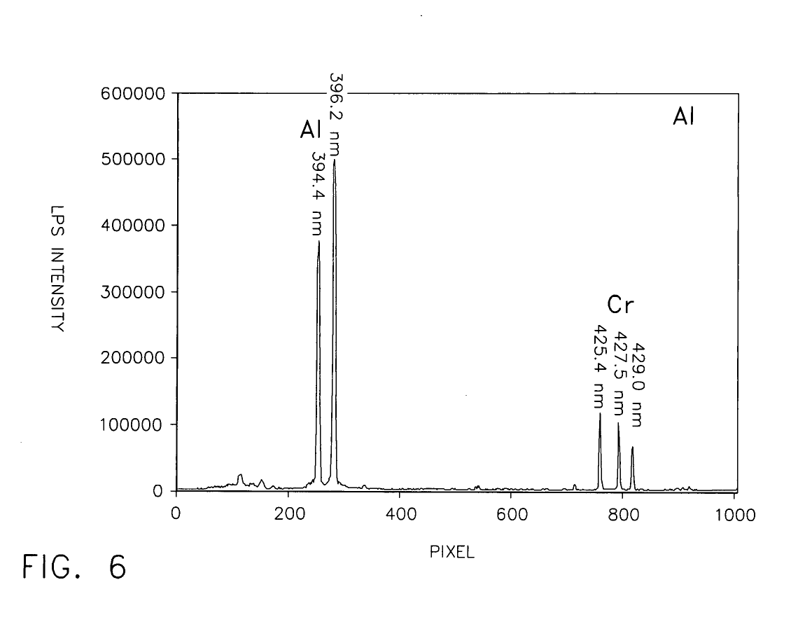

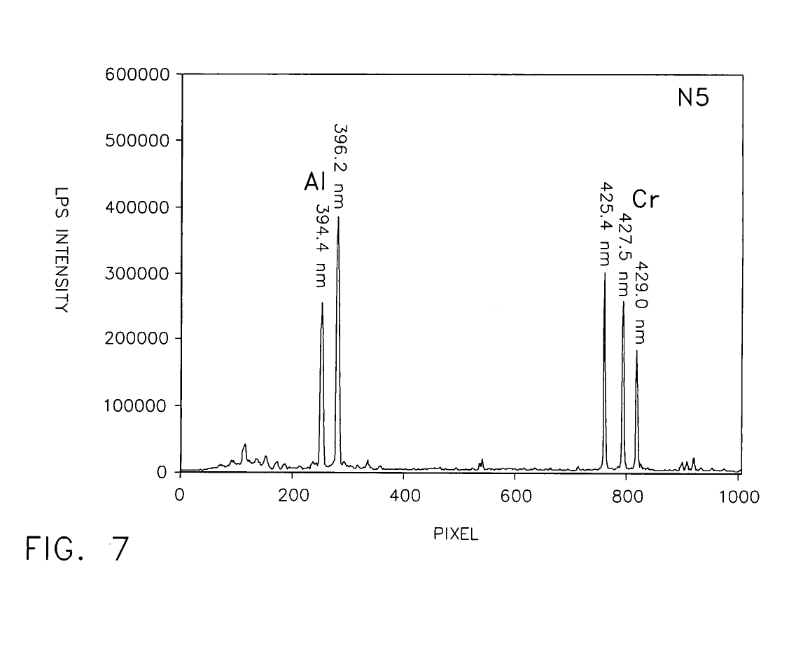

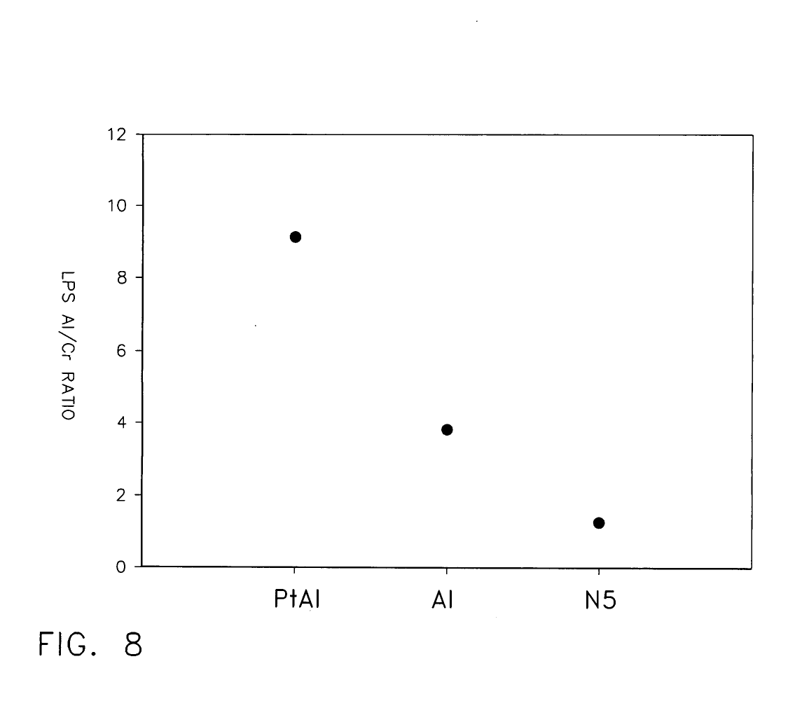

Another embodiment of the method of this invention may comprise analyzing the external surface of the metal substrate of the turbine component by LPS to determine the coating composition, the quantitative elemental concentration in the coating, the coating thickness, etc. For example, LPS may be used to determine: (a) the presence or absence of external layer 70 on surfaces 14 and 16 of blade 70; (b) the elemental composition of external layer 70; (c) the elemental concentration in external layer 70; (d) the thickness of external layer 70; (e) etc. FIGS. 5-7 represent, respectively time-resolved spectra taken by LPS according to embodiments of systems 100 or 200 of a representative platinum aluminide (PtAl) coating (FIG. 5), an aluminide (Al) coating (FIG. 6), and a representative nickel-cobalt (N5) superalloy substrate (FIG. 7). The spectra shown in FIGS. 5-7 are marked to show the presence of aluminum (Al) and chromium (Cr) which represent marker elements. As graphically displayed in FIG. 8 (based on averaging the peak emissions from many spectra of the type shown in FIGS. 5-7), the ratio of two marker elements present in coating 106 and/or substrate 104, for example, the ratio of Al to Cr, may be used to differentiate between coating types and to indicate the presence or absence of the coating.

In determining the thickness of the analyzed coating 106 of sample 102, an ablation rate calibration curve, such as that shown in FIG. 9, may be used. The calibration curve shown in FIG. 9 may be derived or obtained by monitoring the ratio of Al to Cr determined during successive shots or pulses of the laser which strike the surface of coating 106. The number of laser shots or pulses is represented in FIG. 9 on the x-axis as the ablation time,. The depth that the laser pulse(s) cuts or penetrates into coating 106 per laser shot or pulse over a given ablation time is represented as the ablation depth on the y-axis. By monitoring spectra from plasma plume 110 using LPS, when the ratio of Al to Cr drops greatly or abruptly, indicating that the laser pulse(s) has completely cut through or penetrated coating 106 to underlying substrate 104, and by checking the total ablation time (as indicated by the abrupt drop in the Al to Cr ratio) against an ablation rate calibration curve such as that shown in FIG. 9, the coating thickness (ablation depth) may be obtained.

In another embodiment of the method of this invention, the external surface of the metal substrate of the turbine component may be analyzed by LPS after the external surface has been subjected to treatment to remove a metallic coating applied to the external surface to determine the degree of removal of the metallic coating from the treated external surface. For example, if the presence of an external layer 70 were detected by LPS (or if it is assumed that external layer 70 may be present), blade 10 may be subjected to a treatment step to remove the detected or assumed to be present external layer 70, followed by LPS analysis to determine the degree to which external layer 70 has been removed. If needed because the presence of external layer 70 is detected by LPS to a degree that requires further treatment, the treatment step may be repeated one or more times, followed by subsequent LPS analysis to determine the degree to which removal of the external layer 70 has progressed. For example, an ablation rate calibration curve such as that shown in FIG. 9 may be used to determine the degree to which removal of the external layer 70 has progressed.

Various methods or combinations of methods known in the art for treating external layers 70 comprising diffusion coatings (e.g., simple aluminide diffusion coatings), overlay metal alloy coatings (e.g., MCrAlY coatings), etc., to remove such coatings may be used. For example, external layers 70 comprising aluminide diffusion coatings or overlay metal alloy coatings may be chemically stripped by using an inorganic acid such as hydrochloric acid, nitric acid, phosphoric acid, etc., or a mixture thereof. See, for example, commonly assigned U.S. Pat. No. 5,944,909 (Reeves et al.), issued Aug. 31, 1999; U.S. Pat. No. 6,355,116 (Chen et al.), issued Mar. 12, 2002; and U.S. Pat. No. 7,008,553 (Wustman et al.), issued Mar. 7, 2006, the relevant portions of which are incorporated by reference. These external layers 70 may also be subjected to chemically stripping by using organic sulfonic acids. See, for example, commonly assigned U.S. Pat. No. 5,976,265 (Sangeeta et al.), issued Nov. 2, 1999; and U.S. Pat. No. 6,494,960 (MacDonald et al.), issued Dec. 17, 2002, the relevant portions of which are incorporated by reference. These external layers 70 may also be subjected to chemically stripping by treatment with a halogen gas, for example, hydrogen fluoride gas (e.g., fluoride ion cleaning). See commonly assigned U.S. Pat. No. 5,728,227 (Reverman), issued Mar. 17, 1998, the relevant portions of which are incorporated by reference. These external layers 70 may also be subjected to chemical stripping by using electrochemical stripping. See commonly assigned U.S. Pat. No. 6,599,416 (Kool et al.), issued Jul. 29, 2003; and U.S. Pat. No. 6,969,457 (MacDonald et al.), issued Nov. 29, 2005, the relevant portions of which are incorporated by reference. External layers 70 may also be removed by abrasive treatment, for example, by grit blasting, alone or in combination with other stripping methods. See commonly-assigned U.S. Pat. No. 5,723,078 (Nagaraj et al.), issued Mar. 3, 1998 (especially col. 4, lines 46-66), the relevant portions of which are incorporated by reference.

While specific embodiments of the system and method of this invention have been described, it will be apparent to those skilled in the art that various modifications thereto can be made without departing from the spirit and scope of this invention as defined in the appended claims.

What is claimed is:

1. A method comprising the following steps:
(a) providing a turbine component comprising a metal substrate having an external surface; and
(b) analyzing the external surface by laser plasma spectroscopy to determine whether a metallic coating is present on or absent from the external surface.

2. The method of claim 1 wherein step (b) is carried out to determine whether a diffusion coating is present on or absent from the external surface.

3. The method of claim 2 wherein step (b) is carried out to determine whether a simple aluminide diffusion coating is present on or absent from the external surface.

4. The method of claim 1 wherein step (a) is carried out by providing a turbine blade.

5. The method of claim 4 wherein step (a) is carried out by providing a turbine blade with an internal surface having a simple aluminide diffusion coating thereon, and wherein the external surface may or may not have a simple aluminide diffusion coating thereon.

6. The method of claim 1 wherein step (b) is carried out with a portable laser plasma spectroscopy system.

7. The method of claim 1 wherein step (a) is carried out by providing a turbine component wherein the metal substrate comprises a superalloy based on nickel, cobalt and/or iron.

8. The method of claim 7 wherein step (b) is carried out to determine the presence or absence of a simple aluminide diffusion coating on the external surface.

9. The method of claim 1 wherein step (b) is carried out to determine the presence or absence of an overlay metal alloy coating on the external surface.

10. A method comprising the following steps:
(a) providing a turbine component comprising a metal substrate having an external surface;
(b) analyzing the external surface by laser plasma spectroscopy to determine whether a metallic coating is present on or absent from the external surface; and
(c) if a metallic coating is determined to be present on the external surface, determining by laser plasma spectroscopy the elemental composition, elemental concentration and/or thickness of the metallic coating present on the external surface.

11. The method of claim 10 wherein step (c) is carried out to qualitatively determine the elemental composition of the metallic coating present on the external surface.

12. The method of claim 10 wherein step (c) is carried out to determine the elemental concentration of the metallic coating present on the external surface.

13. The method of claim 12 wherein step (c) is carried out by monitoring a ratio of two marker elements present in the metallic coating, the metal substrate or both.

14. The method of claim 13 wherein the marker elements comprise Al and Cr.

15. The method of claim 10 wherein step (c) is carried out to determine the thickness of the metallic coating present on the external surface.

16. The method of claim 15 wherein the thickness of the metallic coating is determined in step (c) by using an ablation rate calibration curve.

17. The method of claim 16 wherein step (c) comprises: (a) monitoring the change in ratio of two marker elements of the metallic coating measured by laser plasma spectroscopy; (b) obtaining a total ablation time when the change in ratio of the marker elements indicates that the metallic coating has been completely penetrated; and (c) comparing the total ablation time to the ablation rate calibration curve to determine the thickness of the metallic coating.

18. The method of claim 17 wherein the change in ratio of Al to Cr is monitored during step (c).

19. The method of claim 10 wherein step (a) is carried out by providing a turbine blade.

20. The method of claim 19 wherein step (a) is carried out by providing a turbine blade with an internal surface having a simple aluminide diffusion coating thereon, and wherein the external surface may or may not have a simple aluminide diffusion coating thereon.

21. The method of claim 10 wherein steps (b) and (c) are carried out with a portable laser plasma spectroscopy system.

22. The method of claim 10 wherein step (a) is carried out by providing a turbine component wherein the metal substrate comprises a superalloy based on nickel, cobalt and/or iron.

23. The method of claim 10 wherein the metallic coating detected during step (b) is a simple aluminide diffusion coating.

24. The method of claim 23 wherein step (c) is carried out to determine the thickness of the simple aluminide diffusion coating.

25. The method of claim 10 wherein step (c) comprises comparing a spectral profile obtained by laser plasma spectroscopy on the metallic coating to a known emission spectra to determine the elemental composition of the metallic coating.

26. The method of claim 10 wherein only selected emissions are collected during step (c).

27. The method of claim 26 wherein resolved spectra have been identified and correlated to differentiate the metallic coatings prior to carrying out step (c).

28. A method comprising the following steps:
(a) providing a turbine component comprising a metal substrate having an external surface which has been subjected to treatment to remove a metallic coating applied to the external surface; and
(b) analyzing the treated external surface by laser plasma spectroscopy to determine the degree of removal of the metallic coating from the treated external surface.

29. The method of claim 28 wherein the metallic coating of step (a) that is subjected to treatment for removal is a simple aluminide diffusion coating.

30. The method of claim 28 wherein the metallic coating of step (a) has been subjected to chemical stripping.

31. The method of claim 28 wherein if the metallic coating is detected during the carrying out of step (b), an additional step (c) is carried out to subject the detected metallic coating to further treatment to remove the detected metallic coating.

32. The method of claim 31 wherein an additional step (d) is carried out after step (c) by laser plasma spectroscopy to determine the degree of removal of the treated detected metallic coating.

33. The method of claim 32 wherein steps (c) and (d) are repeated one or more times.

34. The method of claim 32 wherein the degree of removal of the metallic coating is determined in step (c) by using an ablation rate calibration curve.
